(19) United States
(12) Patent Application Publication
(10) Pub. No.: US 2004/0098722 A1
(43) Pub. Date: May 20, 2004

(54) System, method, and computer program product for operating-system task management

(75) Inventors: Yoshiaki Funaki, Tokyo (JP); Kazuhiro Yokomizo, Tokyo (JP); Masashi Doi, Tokyo (JP)

Correspondence Address: SYNNESTVEDT & LECHNER, LLP, 2600 ARAMARK TOWER, 1101 MARKET STREET, PHILADELPHIA, PA, 191072950

(73) Assignee: International Business Machines Corporation, Armonk, NY

(21) Appl. No.: 10/637,737

(22) Filed: Aug. 8, 2003

(30) Foreign Application Priority Data
Aug. 9, 2002 (JP) 2002-234144

(51) Int. Cl. G06F 9/00

(52) U.S. Cl. 718/103

(57) ABSTRACT

An OS for scheduling in accordance with a type of a process is switched, thereby efficiently performing a mutually exclusive process or input/output process. In a first operating system, a task management system for managing scheduling of a plurality of tasks includes: a task management section which is scheduled by the first operating system and which schedules and manages multiple tasks; and a task execution control section for allowing one of the tasks to be scheduled at a priority higher than that of the task management section by the first operating system, when the one task is determined to be scheduled in preference to the other tasks.

### BACKGROUND OF THE INVENTION

1. Field of the Invention

The present invention relates to task management systems and, more particularly, to a task management system capable of operating with a plurality of operating systems.

An operating system (OS) is a software program that manages the basic operations of and tasks performed by a computer system. OS's have been developed that allow multiple OS's to operate together, e.g., a second OS to operate on a first OS. In such a system, tasks which typically can operate with only one of the OS's can co-exist and be operated on the same computing device. Therefore, a user can execute a wide variety of applications on the same computing device, giving the user a highly-convenient computing environment.

However, in these systems, once a particular OS has scheduled a particular task and execution of that task begins, the system cannot be switched to operate under an alternate OS until completion of the executing task.

### SUMMARY OF THE INVENTION

An object of the present invention is to provide a system, method, and computer program product for implementing an OS task management system that solves the above-described problem. This object is achieved by a combination of characteristics described in independent claims in the scope of the present invention. Moreover, dependent claims further define an advantageous concrete example of the present invention.

According to a first aspect of the present invention, there is provided a task management system for managing scheduling of tasks in a first operating system, comprising a task management section (e.g., module) which is controlled by the first operating system and which schedules and manages the execution of a plurality of tasks, and a task execution control section for allowing a task to be executed at a priority higher than the priority scheduled by the task management section of the first operating system, when one task in the plurality of scheduled tasks is judged to be appropriate for execution in preference to (i.e., before execution of) the other scheduled tasks. There are also provided a control method for controlling the system, a program for realizing the system by a computer, and a recording medium which includes the program recorded thereon.

According to a second aspect of the present invention, there is provided a task management system for managing the scheduling of operating system tasks, comprising a task management section executed by a first operating system which manages the scheduling of a plurality of tasks that function on a second operating system different from the first operating system, and a task execution control section that allows a first task of said plurality of tasks to be executed, when said first task is judged to execute a module executable only by the first operating system. There are also provided a control method for controlling the system, a program for realizing the system by a computer, and a recording medium which includes the program recorded thereon.

It is to be noted that in the above-described summary of the present invention, all necessary characteristics of the present invention are not listed, and a sub-combination of these characteristic groups is considered to be included as the present invention.

### BRIEF DESCRIPTION OF THE DRAWINGS

FIG. 1 is a functional block diagram of a task management system 10;

FIG. 2 is a diagram showing an operational flow of a mutually exclusive process of a POSIX task 110, which is a function by the task management system 10;

FIG. 3 is a detailed diagram of an operation for performing the mutually exclusive process by the POSIX task 110;

FIG. 4 is a diagram showing an operational flow of API execution of ITRON by the POSIX task 110, which is the function by the task management system 10;

FIG. 5 is a detailed diagram of an operation using an input/output function of ITRON by the POSIX task 110;

FIG. 6 shows an example of an operation in a configuration in which the POSIX task executes a module executable only by a first OS 150;

FIG. 7 is a diagram showing an example in which the POSIX task uses an input/output function of ITRON in the present embodiment;

FIG. 8 is a diagram showing a package example of a multiple OS system including the task management system 10 according to the present embodiment; and

FIG. 9 is a diagram showing a hardware configuration of the task management system 10 according to the present embodiment.

### DETAILED DESCRIPTION OF THE PREFERRED EMBODIMENT

The present invention will be described hereinafter through an example for carrying out the present invention, but the following example does not limit the invention as set forth in the claims, and all combinations of characteristics described in the example are not necessarily essential for enabling the present invention.

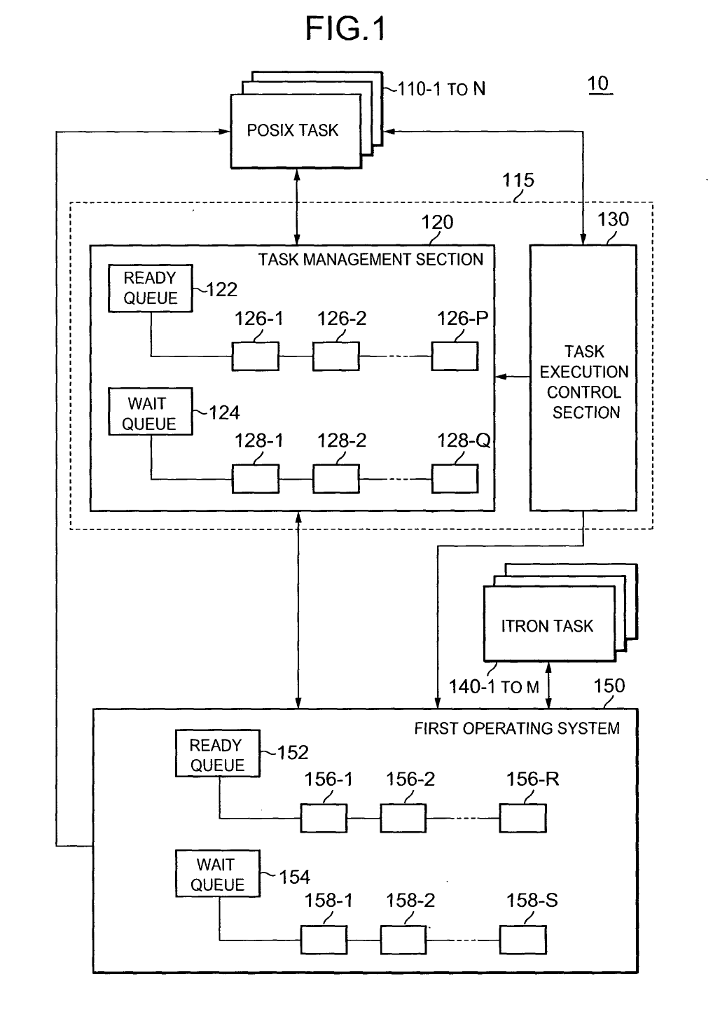

FIG. 1 is a functional block diagram of a task management system 10. The task management system 10 includes a plurality of OS's, and an object of the invention is to switch the OS to be scheduled in accordance with the type of a process and thereby to efficiently perform a mutually exclusive process or an input/output process.

The task management system 10 includes: POSIX (Portable Operating System Interface for UNIX) tasks 110-1 to N which are one example of a plurality of tasks using a function of a second OS 115 different from a first OS 150; the second OS 115 in this example being a non-real-time OS; ITRON tasks 140-1 to M which are a plurality of preferential tasks scheduled in preference to the POSIX tasks 110-1 to N; and the first OS 150 in this example being a real-time OS. In the presently-described embodiment, the second OS 115 can comprise, for example, UNIX (registered trademark) in conformity to POSIX standard, and the first OS 150 can comprise, for example, a micro ITRON. The task management system 10 may instead comprise non-real-time OS such as Linux (registered trademark) and WINDOWS (registered trademark). Both the first OS 150 and second OS 115 may be non-real-time OS. Furthermore, the task management system 10 may include a configuration in which both the first OS 150 and second OS 115 are real-time OS's.

The POSIX tasks 110-1 to N are manageable by the second OS 115, and are tasks of POSIX, and are executed using an application programming interface (hereinafter abbreviated as API) of POSIX to call a process in the second OS 115 and to perform a user's desired process. The execution of the POSIX tasks 110-1 to N is scheduled by either the second OS 115 or the first OS 150 in accordance with the process instructions, and the tasks are executed (e.g., dispatched) by the first OS 150.

It is to be noted that the POSIX tasks 110-1 to N may be developed in a computing environment such as Linux including the API of POSIX, and may also be executed on the task management system 10.

The second OS 115 is executed by the first OS 150, and at least a part of the API of POSIX is provided to the POSIX tasks 110-1 to N in accordance with instructions of the POSIX tasks 110-1 to N. The second OS 115 includes a task management section 120 and task execution control section 130. Here, the second OS 115 manages the POSIX tasks 110-1 to N. Moreover, the second OS 115 does not include all the functions of OS such as POSIX, and may have a function necessary for executing the POSIX tasks 110-1 to N on the task management system 10. When the second OS 115 converts the function of the API of the second OS 115 to the function of the API of the first OS 150, compatibility of the task of the second OS 115 with the task of the first OS 150 is maintained. Moreover, the second OS 115 controls the priority of the scheduling among the tasks, but task dispatching actually executed by hardware does not have to be performed, and task switching does not have to be performed to switch the execution by the hardware.

The task management section 120 includes a ready queue 122, wait queue 124, ready task pointers 126-1 to P, and wait task pointers 128-1 to Q. The task management section 120 is scheduled and executed as one ITRON task for first OS 150 at a priority lower than that of the ITRON tasks 140-1 to M that are specifically designed for execution by the first OS 150. The task management section 120 schedules and manages the POSIX tasks 110-1 to N. For example, the task management section 120 correlates information identifying the POSIX thread for executing the POSIX task 110 as the ready task pointer 126 or wait task pointer 128 to the ready queue 122 or wait queue 124 in a queue form to manage the information.

More specifically, the task management section 120 correlates, to the ready queue 122 in the queue state as the ready task pointers 126-1 to P, the pointer to the POSIX thread which can immediately be executed (but which is not being executed because the other threads are being executed), and it then manages the same. Moreover, when the POSIX thread is in a wait state owing to a factor such as a case where the thread waits until an input/output device which is only exclusively usable can be used, the task management section 120 connects the pointers to the POSIX thread as the wait task pointers 128-1 to Q to the wait queue 124 in the queue form to manage the pointers.

Subsequently, the task management section 120 selects one ready task pointer 126 from the ready task pointers 126-1 to P, and allows the first OS 150 to execute the pointer, and the ready task pointers 126-1 to P are successively scheduled.

Furthermore, the task management section 120 removes some of the ready task pointers 126 or wait task pointers 128 connected to the ready queue 122 or wait queue 124 from the ready queue 122 or wait queue 124 in accordance with the instruction from the task execution control section 130. Additionally, the task management section 120 newly connects the ready task pointer 126 or wait task pointer 128 to the ready queue 122 or wait queue 124 in accordance with the instruction from the task execution control section 130.

The task execution control section 130 provides a part of the API of POSIX in accordance with the instructions from the POSIX tasks 110-1 to N. Moreover, the task execution control section 130 sends an instruction indicating that the scheduling of the thread executing the POSIX tasks 110-1 to N be stopped (or indicating that the scheduling be restarted after being stopped) to the task management section 120 in response to the instructions from the POSIX tasks 110-1 to N. Furthermore, the task execution control section 130 sends an instruction indicating that the scheduling priorities of the POSIX tasks 110-1 to N be changed to the first OS 150 in response to the instructions from the POSIX tasks 110-1 to N.

The ITRON tasks 140-1 to M are programs or modules described using the API provided by the first OS 150 which can be a real-time OS such as ITRON, and are scheduled and executed by the first OS 150. This assures that the execution of the ITRON tasks 140-1 to M are completed in a predetermined time by the first OS 150. The processes of these tasks are completed in a user's desired time without being influenced by the operations of the POSIX task 110 and second OS 115.

The first OS 150 includes a ready queue 152, a wait queue 154, ready task pointers 156-1 to R, and wait task pointers 158-1 to S. The first OS 150 schedules and manages the second OS 115, POSIX tasks 110-1 to N, and ITRON tasks 140-1 to M. For example, the first OS 150 correlates information for identifying the thread executing the ITRON tasks 140-1 to M and the thread executing the POSIX tasks 110-1 to N as the ready task pointers 156 or wait task pointers 158 to the ready queue 152 or wait queue 154 in the queue form to manage the information. In more detail, a method in which the first OS 150 uses the ready queue 152 and wait queue 154 to manage the ready task pointers 156 and wait task pointers 158 is substantially the same as a method in which the task management section 120 uses the ready queue 122 and wait queue 124 to manage the ready task pointers 126 and wait task pointers 128, and therefore the description is omitted.

Moreover, the first OS 150 follows the instruction from the task management section 120 to connect the task pointer of the first OS 150 corresponding to the ready task pointer 126 existing in the top of the ready queue 122 to the ready queue 152, and thereby executes the POSIX task 110. Furthermore, the first OS 150 follows the instruction from the task management section 120 to remove the task pointer to the thread which has executed the POSIX task 110 from the ready queue 152. The pointer is connected to the wait queue 154 to stop the execution of the POSIX task 110.

Moreover, the first OS 150 follows the instruction from the task execution control section 130 to change the scheduling priority of the ITRON tasks which execute the POSIX tasks 110.

The task management system 10 of the present embodiment has the following two functions:

(1) a mutually exclusive process of the POSIX tasks 110; and

(2) execution of ITRON API by the POSIX tasks 110.

These functions will be described hereinafter in order.

### (1) Mutually Exclusive Process of POSIX Tasks 110

The task execution control section 130 manages the mutually exclusive process among the POSIX tasks 110-1 to N in response to the instructions from the POSIX tasks 110-1 to N. For example, the task execution control section 130 receives an instruction indicating the performing of the mutually exclusive process to execute a critical section as an execution portion of a program which has to be exclusively executed only by one thread from the POSIX task 110-N. In this case, the task execution control section 130 sends a scheduling priority change instruction to the first OS 150 so that the POSIX task 110-N is executed in preference to the second OS 115 and the other POSIX tasks 110.

On receiving this, the first OS 150 executes the POSIX task 110-N in preference to the other POSIX tasks 110. Therefore, the task execution control section 130 can execute the critical section by the POSIX task 110-N without being interrupted by the other POSIX tasks 110 and task management section 120.

On the other hand, the task execution control section 130 sends the scheduling priority change instruction to the first OS 150 in order to execute the POSIX task 110-N at the same priority as that of the other POSIX tasks 110, when the execution of the critical section by the POSIX task 110-N ends.

### (2) Execution of ITRON API by POSIX Tasks 110

The task execution control section 130 executes the POSIX tasks 110-1 to N by the first OS 150 in response to the instructions from the POIX tasks 110-1 to N. For example, upon receiving a notice indicating the execution of the module such as the input/output executable only by the first OS 150 (e.g., a process referred to as IO_START) from the POSIX task 110-N, the task execution control section 130 sends an instruction to stop the scheduling of the POSIX task 110-N by the task management section 120 to the task management section 120. Upon receiving this, the task management section 120 stops the scheduling of the POSIX task 110-N by the task management section 120. Therefore, the task execution control section 130 allows the POSIX task 110-N to be scheduled only by the first OS 150. Moreover, when the API of the first OS 150 can be called from the POSIX tasks 110-1 to N, the POSIX task 110 can be executed by the first OS 150.

On the other hand, upon receiving the notice indicating the end of the execution of the module executable only by the first OS 150 (e.g., a process referred to as IO_DONE) from the POSIX tasks 110, the task execution control section 130 sends an instruction to restart the scheduling by the task management section 120 to the task management section 120.

As described above, the task management system 10 can execute both the POSIX task 110 and ITRON task 140 which are programs described using different APIs. Moreover, the task management system 10 can manage the execution of the POSIX tasks 110 and second OS 115 without interrupting the execution of the ITRON task 140 which requires a real-time property.

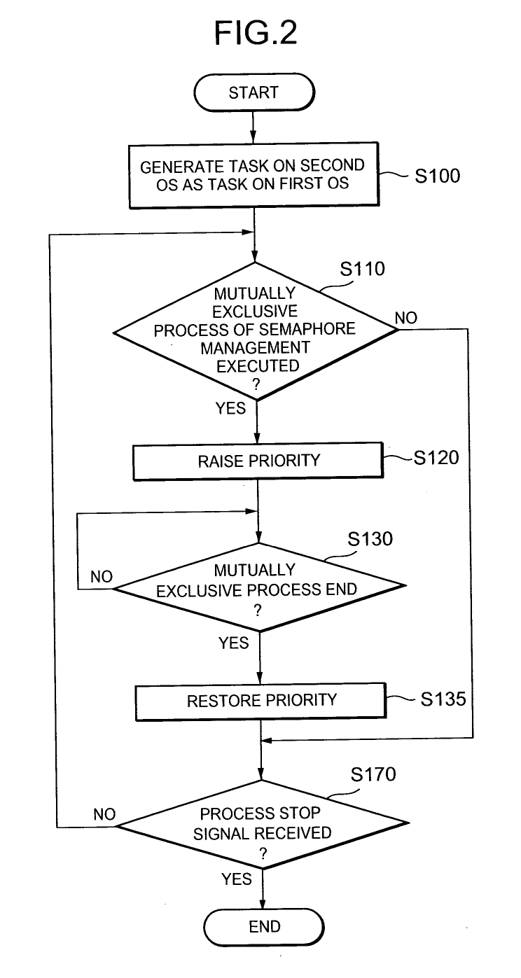

FIG. 2 shows an operation flow of a mutually exclusive process of the POSIX task 110, which is a function of the task management system 10. The task management system 10 generates the POSIX tasks 110-1 to N as the tasks executable on the first OS 150 (S100). Subsequently, the task management system 10 performs the following process in response to calls from the POSIX tasks 110.

The task execution control section 130 judges that the mutually exclusive process for the semaphore management of the POSIX task 110-N is executed in response to the call from one of the POSIX tasks 110-1 to N (e.g., assuming the POSIX task 110-N) (S110: YES). In this case, the first OS 150 raises the scheduling priority of the POSIX task 110-N from that of the task management section 120 (S120). On the other hand, when the mutually exclusive process is judged not to be executed (S110: NO), the task management system 10 performs a usual scheduling operation to successively execute the POSIX tasks 110-1 to N. Moreover, the task execution control section 130 shifts to the next process (S170).

Subsequently, when the task execution control section 130 judges that the mutually exclusive process has been completed (S130: YES), the scheduling priority by the first OS 150 of the POSIX task 110-N is restored to an original priority (S135). On the other hand, when the exclusive process is judged not to be completed(S 130: NO), the task management system 10 performs the usual scheduling operation. Moreover, the task management system 10 returns to the judgment of S130 in response to the call from the POSIX task 110-N.

Here, the mutually exclusive process of the semaphore management called by the POSIX task 110-N may be, for example, a WAKEUP process of the semaphore management, a WAIT process, a MUTEX process defined by the POSIX, or a COND-VAR process. Moreover, the mutually exclusive process is not necessarily used only in the semaphore management, and is used in executing the critical section as the execution region in the program which has to be exclusively executed only by one thread.

When judging that the instruction to interrupt or stop the process of the whole system has been received from the outside (S170: YES), the task management system 10 ends the process after performing a predetermined end process. When judging that the instruction has not been received from the outside (S170: NO), the task management system 10 returns to the process of S110.

The task management system 10 can raise the scheduling priority of the POSIX task 110 in response to the instruction from the POSIX task 110 in this manner. For example, when the POSIX task 110 performs the mutually exclusive process, the task management system 10 raises the scheduling priority by the first OS 150 of the POSIX task 110. Therefore, the task management system 10 can execute the POSIX task 110 in preference to the other tasks managed by the task management section 120 or the task management section 120.

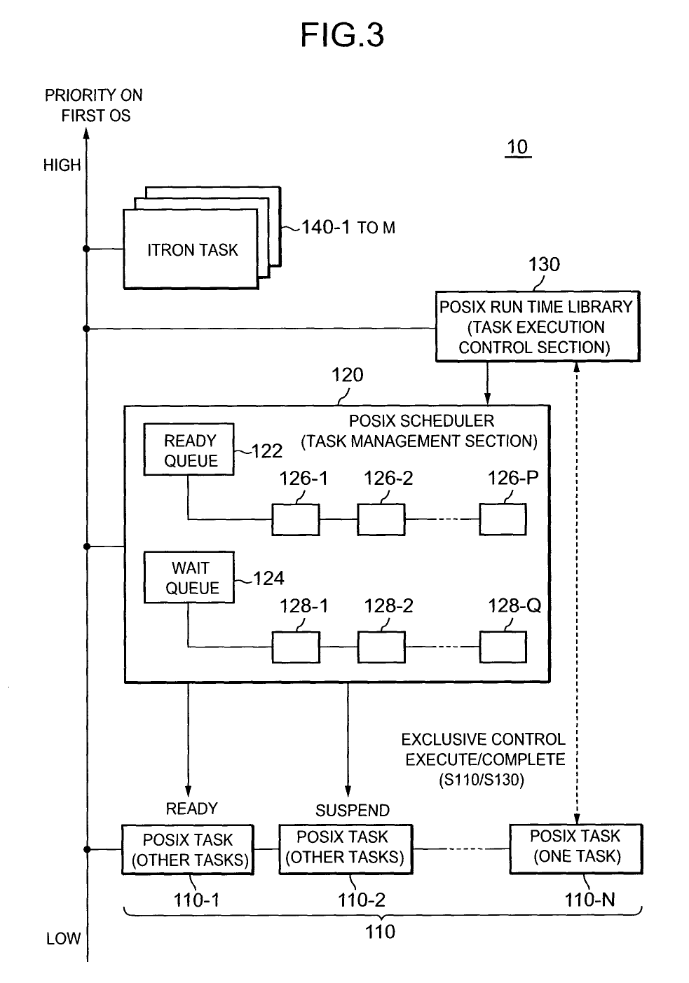

FIG. 3 is a detailed drawing of an operation of the POSIX task performing the mutually exclusive process. In the drawing, a solid arrow of an upper direction indicates the scheduling priority. That is, the task management system 10 preferentially schedules the task in the upper direction of the drawing. The first OS 150 executes the ITRON tasks 140-1 to M, the task execution control section 130 which is a section performing the mutually exclusive process in a POSIX runtime library, the task management section 120 which is the POSIX scheduler, and the POSIX tasks 110-1 to N in an order from a high scheduling priority. The POSIX tasks 110-1 to N are successively brought into an executable state (ready state) and scheduled by the task management section 120. For example, in the drawing, the task management section 120 sets an execution state indicating whether or not one POSIX task 110-1 in the POSIX tasks 110-1 to N is executable on the first OS 150 to an executable state (ready state), and the task is executed by the first OS 150 at a priority lower than that of the task management section 120.

Moreover, after completing the execution of the task which has a higher scheduling priority, the first OS 150 executes the task which has the scheduling priority lower than that of the task. For example, when there is an executable task in the ITRON tasks 140-1 to M, the first OS 150 does not execute the task management section 120.

The task execution control section 130 judges that the POSIX task 110-N executes the mutually exclusive process and that the POSIX task 110-N is scheduled in preference to the other tasks, when called from the POSIX task 110-N as one task in the POSIX tasks 110-1 to N via the API of the mutually exclusive process (S110 of FIG. 2: YES).

On receiving this, the task execution control section 130 changes the scheduling priority by the first OS 150 of the POSIX task 110-N to the value of the task execution control section 130.

On the other hand, when judging that the mutually exclusive process has ended (S 130 of FIG. 2: YES), the task execution control section 130 judges that a state in which POSIX task 110-N is scheduled in preference to the other POSIX tasks 110 has completed. The scheduling priority by the first OS 150 of the POSIX task 110-N is restored to the position of the POSIX task 110, and a state scheduled by the task management section 120 is restored.

In this manner, the task management system 10 judges that the POSIX task 110 is scheduled in preference to the other POSIX tasks 110, when the POSIX task 110 executes the mutually exclusive process. Moreover, in the task management system 10, since the POSIX task 110 is scheduled at the priority higher than that of the task management section 120 or the other POSIX tasks 110, and the process of the POSIX task 110 is not obstructed by the other POSIX tasks 110, an appropriate mutually exclusive process can be performed. Furthermore, in this case, the task management system 10 allows the POSIX task 110 to be scheduled at the priority lower than that of the ITRON task 140, and the above-described process can be executed without adversely influencing the process of the ITRON task 140.

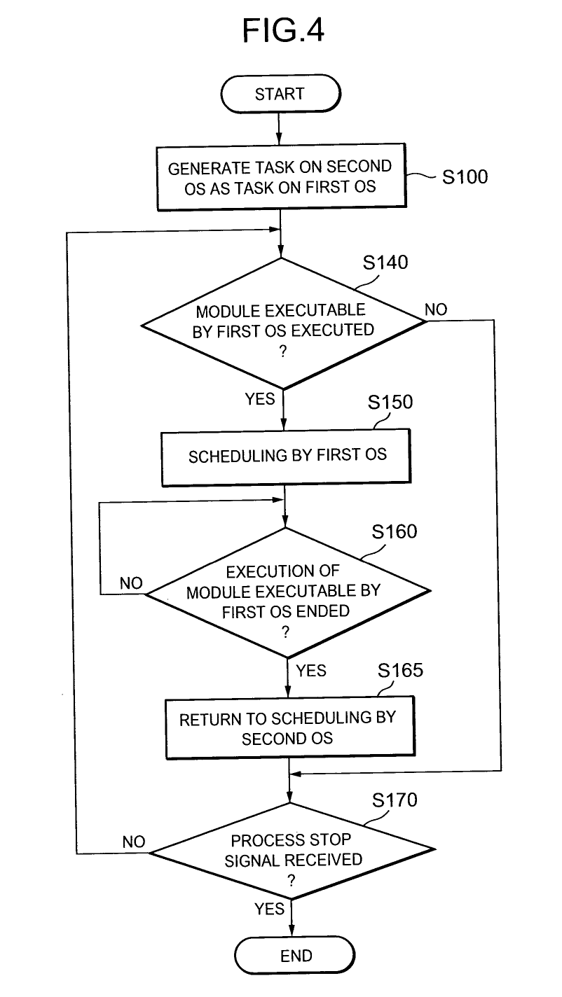

FIG. 4 is a chart showing the operational flow of the API execution of ITRON by the POSIX task 110, which is the function by the task management system 10. The task management system 10 generates the POSIX tasks 110-1 to N as the executable tasks on the first OS 150 (S100). Subsequently, the task management system 10 performs the following process, for example, in response to the call from the POSIX task 110.

The task execution control section 130 judges whether or not the POSIX task 110-N executes the module executable only by the first OS 150 (S 140). The task execution control section 130 stops the scheduling of the POSIX task 110-N by the task management section 120 and allows the scheduling only by the first OS 150 (S150), when judging that the POSIX task 110-N executes the module executable only by the first OS 150 (S 140: YES). It is to be noted that in this case the task execution control section 130 may raise the scheduling priority of the POSIX task 110-N by the first OS 150.

On the other hand, when the module executable only by the first OS 150 is judged not to be executed by the POSIX task 110-N (S140: NO), the task management system 10 shifts to the next process (S170).

Subsequently, when the task execution control section 130 judges that the POSIX task 110-N has ended the execution of the module executable only by the first OS 150 (S160: YES), the section returns the POSIX task 110-N to the state scheduled by the task management section 120 (S165).

When the task management system 10 judges that the instruction to interrupt or stop the process of the whole system has been received from the outside (S170: YES), the system ends the process after performing a predetermined end process. When judging that the instruction has not been received from the outside (S170: NO), the task management system 10 returns to the process of S140.

In this manner, the task management system 10 can switch the OS that schedules the POSIX task 110 in response to the instruction from the POSIX task 110. For example, when the POSIX task 110 performs the input/output process executable only by the first OS 150, the task management system 10 stops the scheduling of the POSIX task 110 by the task management section 120, and the scheduling of the other POSIX tasks 110 by the task management section 120 can efficiently be performed.

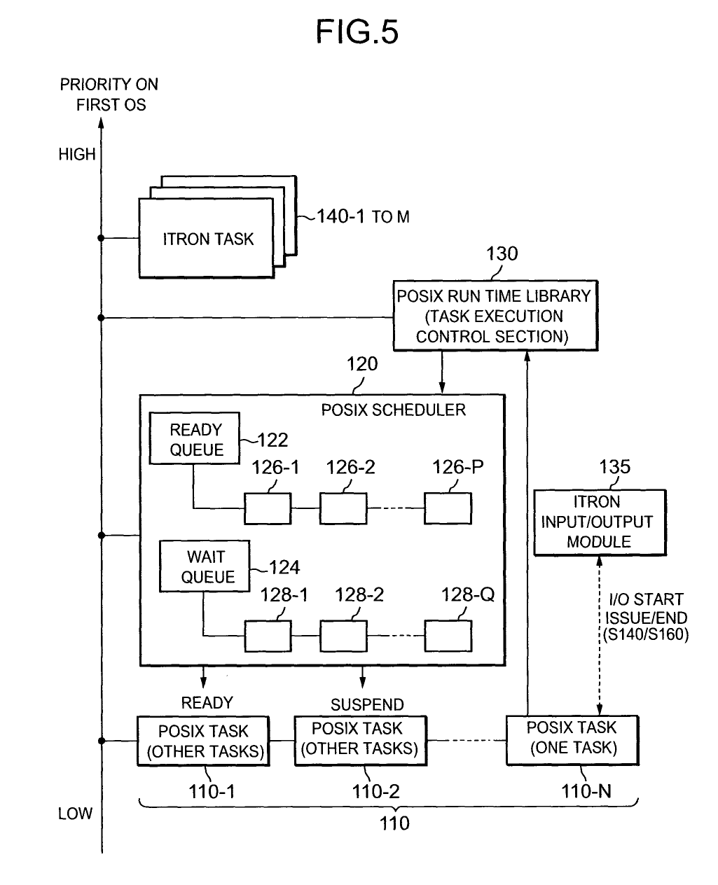

FIG. 5 is a detailed diagram of an operation of the POSIX task using the input/output function of ITRON. The solid arrow of the upper direction of this diagram indicates the scheduling priority in the same manner as in FIG. 3. Since the details of the scheduling priority are similar to the thread having the same reference numerals in FIG. 3, the description is omitted.

Upon receiving the notice indicating the execution of the module executable only by the first OS 150 (e.g., the process referred to as IO_START) from the POSIX task 110-N (S140 of FIG. 4: YES), the task execution control section 130 stops the scheduling of the POSIX task 110-N by the task management section 120. That is, when IO_START of the task execution control section 130 is called, the thread executing the POSIX task 110-N removes the ready task pointer 126 for use in scheduling the thread from the task management section 120, and executes an ITRON input/output module 135.

On the other hand, upon receiving the notice (e.g., the process referred to as IO_DONE) indicating the end of the execution of the module executable only by the first OS 150 from the POSIX task 110 (S160 of FIG. 4: YES), the task execution control section 130 restarts the scheduling by the task management section 120. That is, when the process of the ITRON input/output module 135 is ended, the thread which has executed the task execution control section 130 newly adds the ready task pointer 126 for use in scheduling the thread into the task management section 120, and restores the real-time thread under the management of the task management section 120.

When the POSIX task 110 is judged to execute the module executable only by the first OS 150 in this manner, the task management system 10 stops the scheduling of the POSIX task 110 by the task management section 120, and allows the POSIX task 110 to be scheduled by the first OS 150. Accordingly, the scheduling of the other POSIX tasks 110 by the task management section 120 can efficiently be processed.

Here, for the task management system 10, when the scheduling of the POSIX task 110 by the task management section 120 was not stopped, and the POSIX task 110 was brought in a resource wait state of the first OS 150, the scheduling of the other POSIX tasks 110 by the task management section 120 would be obstructed. This occurs because the task management section 120 cannot detect the wait state caused by the API execution of the first OS 150 by the POSIX task 110. Therefore, as described above, the task management system 10 switches the OS scheduled in accordance with the type of the API for use, whereby the thread can entirely efficiently be operated.

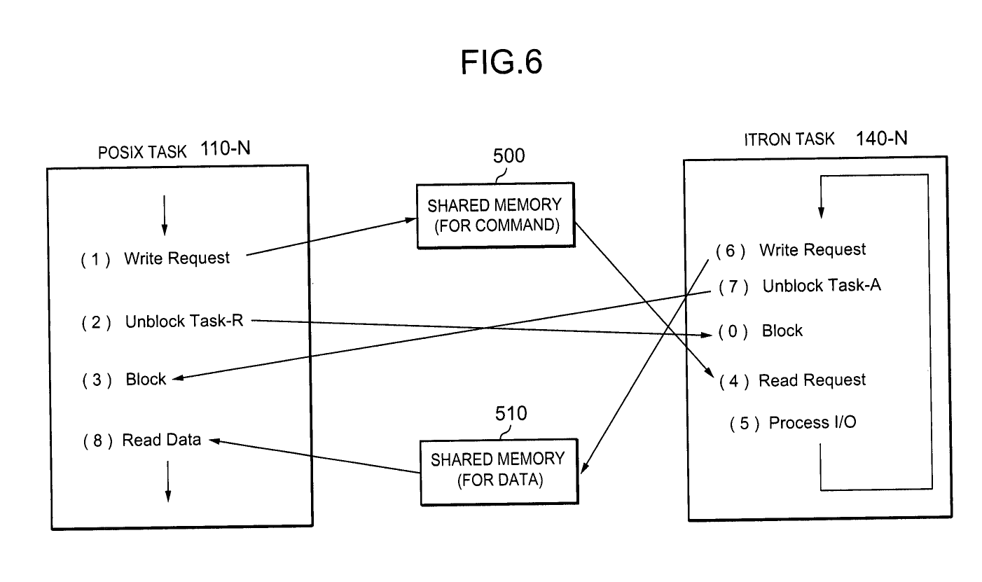

FIG. 6 shows an example of the operation of the present invention in a configuration in which the POSIX task executes the module executable only by the first OS 150. In this example, the task management system 10 includes the POSIX task 110-N, the ITRON task 140-N, a shared memory for command 500 for use in receiving the command, and a shared memory for data 510 for use in receiving the data. The solid arrow shown in the drawing indicates write and read of the data or instruction between the POSIX task 110N and ITRON task 140-N. Moreover, the task management system 10 generates the thread for executing the ITRON tasks 140 associated with the POSIX tasks 110 beforehand. In the drawing, an operational example will be described in which the thread executing the POSIX task 110-N uses the ITRON task 140-N corresponding to the POSIX task 110-N to perform a process using the input/output module as the module executable only by the first OS 150.

The ITRON task 140-N is set to a state waiting for a request from the POSIX task 110-N, which is an initial state ((0) Block). Here, the POSIX task 110-N writes a read instruction to read the data from the input/output module in the shared memory for command 500 ((1) Write Request). Moreover, the POSIX task 110-N cancels the wait state of the ITRON task 140-N ((2) Unblock Task-R), and sets a state waiting for a read result from the ITRON task 140-N ((3) Block).

The ITRON task 140-N receives the read instruction from the shared memory for command 500 ((4) Read Request), and reads the data from the input/output module in accordance with the read instruction ((5) Process I/O). Subsequently, the ITRON task 140-N writes the read data in the shared memory for data 510 ((6) Write Result), and cancels the wait state of the POSIX task 110-N ((7) Unblock Task-A). Upon receiving this, the POSIX task 110-N reads a data value which is the result of the read instruction from the shared memory for data 510 ((8) Read Data), and continues the operation using this data value.

In the configuration as described above, the POSIX task 110-N generates the ITRON task 140-N for executing the module executable only by the first OS 150 beforehand, and thereby the ITRON task 140-N can be used to perform a desired process. However, in the drawing, the task management system 10 needs to generate the thread for executing the ITRON task 140-N beforehand, and has to generate more threads than originally required threads based on the content of the process. Therefore, efficiency is poor. Moreover, as shown in the drawing, since the thread for executing the POSIX task 110-N needs to perform unnecessary communication with the thread for executing the ITRON task 140-N, the efficiency is poor. Furthermore, for the POSIX task 110-N, even in the operation of only reading the value using the input/output module, a complicated program shown in the drawing is required. Therefore, there is a possibility that a program size increases or an execution efficiency is adversely influenced.

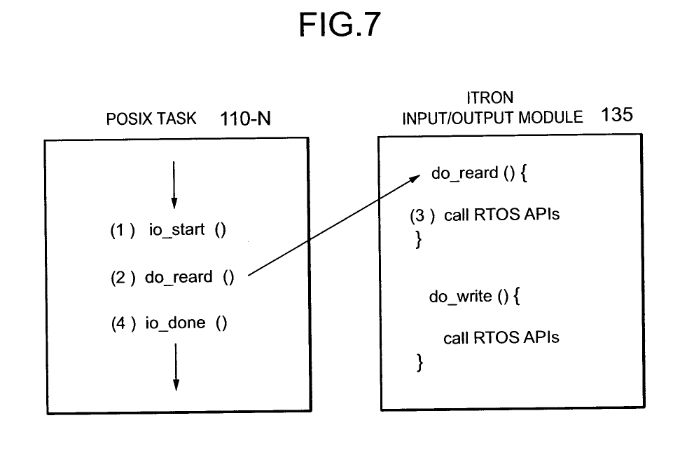

FIG. 7 is a diagram showing an example in which the POSIX task uses the input/output function of ITRON in the present embodiment. The solid arrow shown in the present drawing indicates a function call to the ITRON input/output module 135 from the POSIX task 110-N. In the drawing, an operational example will be described in which the POSIX task 110-N performs a process using the module executable only by the first OS 150 by the function call in the ITRON input/output module 135.

The real-time thread of ITRON for executing the POSIX task 110-N calls IO_START in a state in which the POSIX task 110-N described by the API of POSIX is executed ((1) io_start ( ). Upon receiving this, the task execution control section 130 stops the scheduling by the task management section 120 of the POSIX task 110-N.

Subsequently, the real-time thread of ITRON for executing the POSIX task 110-N calls the function in the ITRON input/output module 135 ((2) do_read ( ), and performs the input/output ((3) call RTOS APIs) in order to execute the module executable only by the first OS 150. The real-time thread of ITRON for executing the POSIX task 110-N ends the execution of the ITRON input/output module 135, and IO_DONE ((4) io_done ( ). Accordingly, the real-time thread of ITRON for executing the POSIX task 110-N is returned to a state of the scheduling by the task management section 120 again.

The task management system 10 can allow one thread to call both the API of POSIX and API of ITRON in this manner. Moreover, for the task management system 10, inter-thread communication which has been performed in a method of FIG. 6 is not required, and therefore a communication cost of the inter-thread communication, complicated program for the inter-thread communication, and thread generation exclusive for the input/output are not required.

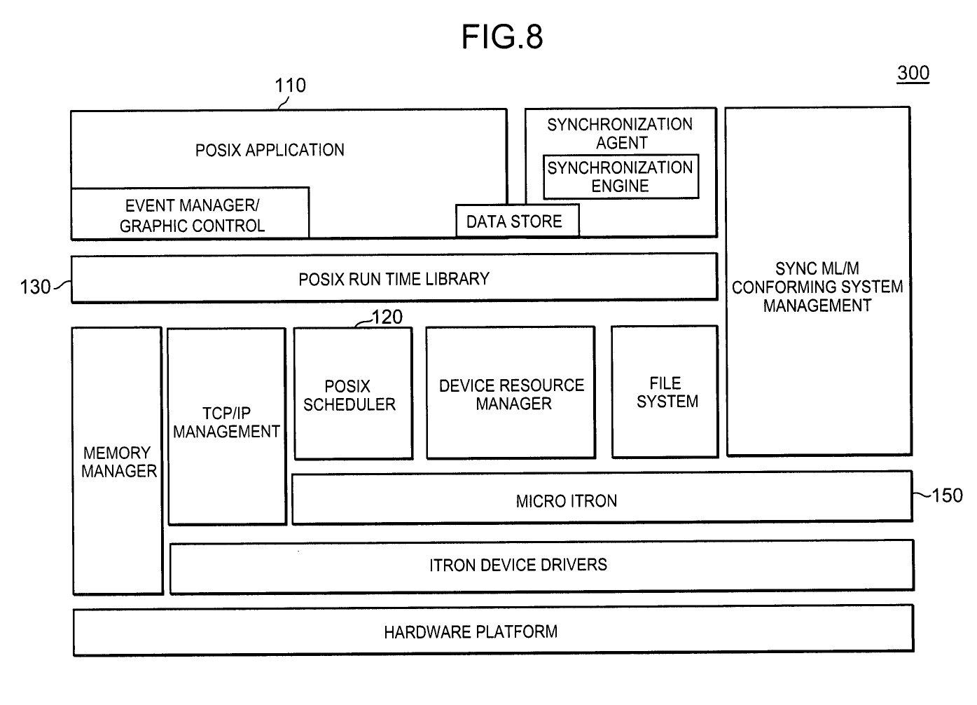

FIG. 8 is a diagram showing a package example of a multiple OS system 300 which includes the task management system 10 shown in the present embodiment. Each rectangular region of this drawing shows the module realized by hardware or software. Moreover, the module disposed in an upper part in the drawing operates dependent on the function of the module disposed below.

The multiple OS system 300 includes: a hardware platform of a home appliance (e.g., a PC or PDA), cellular phone, and meter; a memory manager which effectively uses the memory of the hardware platform; an ITRON device driver which manages the input/output by the hardware platform. Moreover, the multiple OS system 300 includes: a TCP/IP management module which performs communication control using the ITRON device driver; and the micro ITRON 150 which is a kernel which manages the ITRON device driver.

Furthermore, the multiple OS system 300 includes: a POSIX scheduler for operating on the micro ITRON 150 to schedule the POSIX task; a device resource manager for performing the resource management of the micro ITRON 150; a file system module for managing a file system of the micro ITRON 150; and a Sync ML/M conforming system management module for managing data synchronization for a mobile apparatus. The function of the task management section 120 shown in FIG. 1 is realized by the POSIX scheduler shown in the drawing.

Additionally, the multiple OS system 300 includes a POSIX runtime library in which the memory manager, TCP/IP management module, POSIX scheduler, device resource manager, and file system module are used to provide POSIX API to a user level application. The function of the task execution control section 130 shown in FIG. I is realized by the POSIX runtime library.

Moreover, the multiple OS system 300 includes an event manager/graphic control module, POSIX application 110, data store, and synchronization agent including a synchronization engine, which operate on the POSIX runtime library.

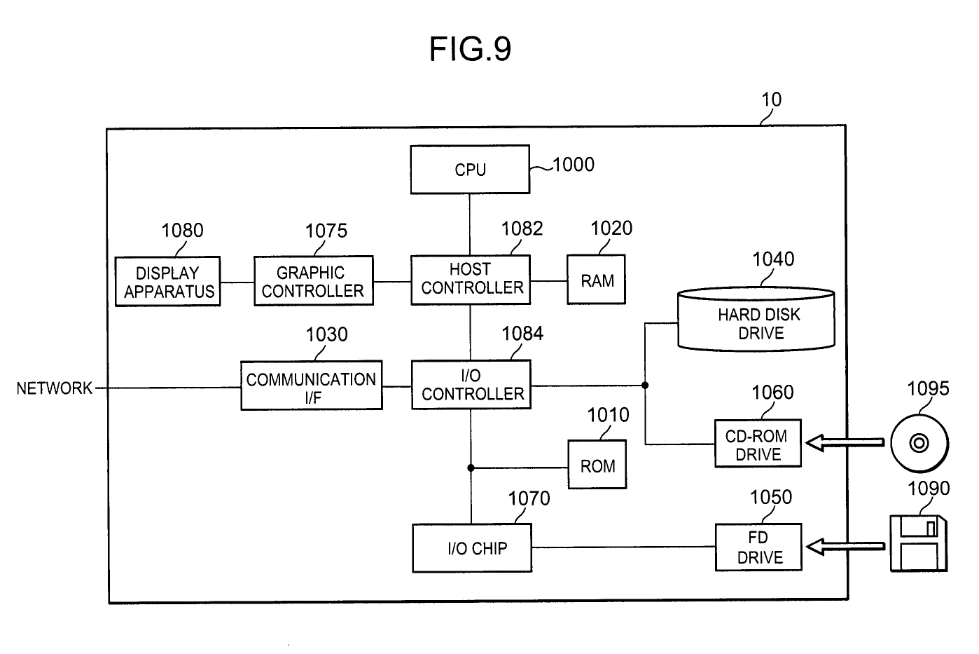

FIG. 9 shows a hardware configuration of the task management system 10 shown in the present embodiment. The task management system 10 according to the present embodiment includes: a CPU peripheral section including a CPU 1000, RAM 1020, graphic controller 1075, and display apparatus 1080 connected to one another via a host controller 1082; an input/output section including a communication interface 1030, hard disk drive 1040, and CD-ROM drive 1060 connected to the host controller 1082 via an input/output controller 1084; and a legacy input/output section including a ROM 1010, flexible disk drive 1050, and input/output chip 1070 connected to the input/output controller 1084.

The host controller 1082 connects the RAM 1020 to the CPU 1000 and graphic controller 1075 which access the RAM 1020 at a high transfer rate. The CPU 1000 operates and controls each section based on the program stored in the ROM 1010 and RAM 1020. For the graphic controller 1075, the CPU 1000 acquires image data generated on a frame buffer disposed in the RAM 1020, and displays the data on the display apparatus 1080. Alternatively, the graphic controller 1075 may include the frame buffer storing the image data generated by the CPU 1000.

The input/output controller 1084 connects the host controller 1082 to the communication interface 1030, hard disk drive 1040, and CD-ROM drive 1060 which are relatively high rate input/output apparatuses. The communication interface 1030 communicates with another apparatus via a network. The hard disk drive 1040 stores the program and data for use by the task management system 10. The CD-ROM drive 1060 reads the program or data from a CD-ROM 1095, and supplies the program or data to the input/output chip 1070 via the RAM 1020.

Moreover, the input/output controller 1084 is connected to the ROM 1010, and the flexible disk drive 1050 or input/output chip 1070 which is a relatively low rate input/output apparatus. The ROM 1010 stores a boot program executed by the CPU 1000 at a start time of the task management system 10, and a program which depends on the hardware of the personal computer main body 110. The flexible disk drive 1050 reads the program or data from a flexible disk 1090, and supplies the program or data to the input/output chip 1070 via the RAM 1020. The input/output chip 1070 connects the flexible disk 1090, or various input/output apparatuses, for example, via a parallel port, serial port, keyboard port, and mouse port.

The program for realizing the task management system 10 includes a task management module, and task execution control module. These modules are programs for operating the task management system 10 as the task management section 120 and task execution control section 130.

The program supplied to the task management system 10 is stored in the ROM 1010, hard disk drive 1040, flexible disk 1090, CD-ROM 1095, and recording mediums such as an IC card, and is supplied by a user. This program is read from the recording medium, installed in the hard disk drive 1040 via the input/output chip 1070, and executed on the task management system 10. Moreover, the program supplied to the task management system 10 may be read from the recording medium, and stored or used in the ROM 1010.

The above-described program or module may also be stored in an outside storage medium. As the storage medium, in addition to the flexible disk 1090 and CD-ROM 1095, it is possible to use optical recording mediums such as a DVD and PD, magnetic optical recording mediums such as an MD, a tape medium, and semiconductor memories such as the IC card. Moreover, storage apparatuses such as the hard disk and RAM disposed in an exclusive-use communication network or a server system connected to internet are used as the recording mediums, and the program may also be supplied to the task management system 10 via the network.

As apparent from the above description, the task management system 10 can efficiently execute a plurality of tasks described in APIS which are standard functions supplied by the operating systems different from one another. For example, when the task management system 10 judges that one of the plurality of tasks of the second OS 115 performs the mutually exclusive process, one task is scheduled at the priority higher than that of the task management section 120 by the first OS 150, and thereby the mutually exclusive process can be performed.

Moreover, the task management system 10 can use the functions provided by the plurality of operating systems in the same task. For example, the task management system 10 can call the API of the real-time OS such as the ITRON during the execution of the program described using the API of the POSIX. Therefore, the task management system 10 can efficiently perform the input/output process.

According to the above-described embodiment, the task management system, program, recording medium, and control method described in the following items are realized.

(Item 1) A task management system for managing scheduling of tasks in a first operating system, comprising: a task management section which is scheduled by the first operating system and which schedules and manages a plurality of tasks; and a task execution control section for allowing the one task to be scheduled by the first operating system at a priority higher than that of the task management section, when the one task in the plurality of tasks is judged to be scheduled in preference to the other tasks.

(Item 2) The task management system according to item 1, wherein the plurality of tasks are the tasks of a second operating system executed on the first operating system, and the task management section schedules and manages the plurality of tasks which are the tasks of the second operating system.

(Item 3) The task management system according to item 1, wherein the first operating system executes a plurality of preferential tasks scheduled in preference to the plurality of tasks.

(Item 4) The task management system according to item 3, wherein the task management section is scheduled at a priority lower than that of the plurality of preferential tasks, and the task execution control section allows the one task to be scheduled at a priority higher than that of the task management section and lower than that of the plurality of preferential tasks, when the one task is judged to be scheduled in preference to the other tasks.

(Item 5) The task management system according to item 1, wherein the task execution control section allows the one task to be scheduled at a priority higher than that of the task management section, when the one task is judged to execute a mutually exclusive process with respect to the other tasks.

(Item 6) The task management system according to item 5, wherein the task execution control section allows the one task to be scheduled at a priority higher than that of the task management section, when the one task is judged to execute the mutually exclusive process for a semaphore management.

(Item 7) The task management system according to item 1, wherein the task execution control section restores the one task to a state scheduled by the task management section, when a state of the one task scheduled in preference to the other tasks is ended.

(Item 8) The task management system according to item 1, wherein a function of a second operating system different from the first operating system is used to generate the plurality of tasks as the tasks executable on the first operating system, and

The task management section changes an execution state indicating whether or not the plurality of tasks can be executed on the first operating system to allow the first operating system to schedule the plurality of tasks.

(Item 9) The task management system according to item 8, wherein the task management section selects one task from the plurality of tasks and allows the first operating system to execute the task to successively schedule the plurality of tasks.

(Item 10) The task management system according to item 1, wherein the first operating system is a real-time operating system, and schedules the tasks of a non-real-time operating system to manage the plurality of tasks.

(Item 11) A task management system for managing scheduling of tasks in a first operating system, comprising: a task management section which manages a plurality of tasks using a function of a second operating system different from the first operating system and which is executed by the first operating system; and a task execution control section for allowing the one task to be executed by the first operating system, when the one task in the plurality of tasks is judged to execute a module executable only by the first operating system.

(Item 12) The task management system according to item 11, wherein the plurality of tasks are generated as the tasks executable on the first operating system, the task management section changes an execution state indicating whether or not the plurality of tasks can be executed on the first operating system to schedule the plurality of tasks, and the task execution control section stops the scheduling of the one task by the task management section to allow the one task to be scheduled by the first operating system and to allow the one task to be executed by the first operating system, when the one task is judged to execute the module executable only by the first operating system.

(Item 13) The task management system according to item 11, wherein the task execution control section returns the one task to a state scheduled by the task management section, when the execution of the module executable only by the first operating system is judged to have been ended.

(Item 14) A program which controls a task management system for managing scheduling of tasks by a computer in a first operating system and which allows the computer to function as: a task management section which is scheduled by the first operating system and which schedules and manages a plurality of tasks; and a task execution control section for allowing the one task to be scheduled at a priority higher than that of the task management section by the first operating system, when the one task in the plurality of tasks is judged to be scheduled in preference to the other tasks.

(Item 15) A program which controls a task management system for managing scheduling of tasks by a computer in a first operating system and which allows the computer to function as: a task management section which manages a plurality of tasks using a function of a second operating system different from the first operating system and which is executed by the first operating system; and a task execution control section for allowing the one task to be executed by the first operating system, when the one task in the plurality of tasks is judged to execute a module executable only by the first operating system.

(Item 16) A recording medium in which the program according to item 14 or 15 is recorded.

(Item 17) A control method for controlling scheduling of tasks in a first operating system, comprising: a task management step which is realized as the task scheduled by the first operating system and which manages a plurality of tasks; and a task execution control step of allowing the one task to be scheduled at a priority higher than that of the task management step by the first operating system, when the one task in the plurality of tasks is judged to be scheduled in preference to the other tasks.

(Item 18) A control method for controlling a task management system for managing scheduling of tasks by a computer in a first operating system, comprising: a task management step of managing a plurality of tasks that use a function of a second operating system different from the first operating system, the step being executed by the first operating system; and a task execution control step of allowing the one task to be scheduled by the first operating system, when the one task in the plurality of tasks is judged to execute a module executable only by the first operating system.

The present invention has been described above using the embodiment, and a technical scope of the present invention is not limited to the scope described above in the mode for carrying out the present invention. Various changes or improvements can be added to the above-described mode. Even the modes to which the changes or improvements are added can be included in the technical scope of the present invention, as apparent from the description of the scope of the claims.

As apparent from the above description, an OS to be scheduled is switched in accordance with the type of a process according to the present invention, and a mutually exclusive process or input/output process can efficiently be performed.

1. A task management system for managing scheduling of tasks in a first operating system, comprising:
a task management section that operates using the first operating system and which manages the execution scheduling of a plurality of tasks; and
a task execution control section that allows a first task of said plurality of tasks to be scheduled for execution by the first operating system at a priority higher than a priority scheduled by the task management section, when said first task is determined to be appropriate for scheduling before the other of said plurality of tasks.

2. The task management system according to claim 1, wherein the plurality of tasks include the tasks of a second operating system executable on the first operating system, and
the task management section manages the execution scheduling of the plurality of tasks that are the tasks of the second operating system executable on the first operating system.

3. The task management system according to claim 1, wherein the first operating system executes a plurality of preferential tasks that supercedes the priority schedule for the plurality of tasks set by the task management section of said first operating system.

4. The task management system according to claim 3, wherein the tasks scheduled by the task management section are scheduled at a priority lower than the priority of the plurality of preferential tasks, and
the task execution control section allows said first task to be scheduled at a priority higher than that of tasks scheduled by the task management section and lower than that of the plurality of preferential tasks, when said first task is judged to be scheduled in preference to the other of said plurality of tasks.

5. The task management system according to claim 1, wherein the task execution control section allows said first task to be scheduled at a priority higher than that of the tasks scheduled by the task management section, when said first task is judged to execute a mutually exclusive process with respect to the other tasks.

6. The task management system according to claim 5, wherein the task execution control section allows said first task to be scheduled at a priority higher than that of the tasks scheduled by the task management section, when said first task is judged to execute the mutually exclusive process for semaphore management.

7. The task management system according to claim 1, wherein the task execution control section returns said first task to a scheduling state scheduled by the task management section, when execution of said first task scheduled in preference to the other of said plurality of tasks is ended.

8. The task management system according to claim 1, wherein the second operating system includes a function to generate the plurality of tasks executable on the first operating system, and
the task management section changes an execution state of said plurality of tasks indicating whether or not the plurality of tasks can be executed on the first operating system to allow the first operating system to schedule the plurality of tasks.

9. The task management system according to claim 8, wherein the task management section selects one task from the plurality of tasks and allows the first operating system to execute the task to successively schedule the plurality of tasks.

10. The task management system according to claim 1, wherein the first operating system is a real-time operating system, and
schedules the tasks of a non-real-time operating system to manage the plurality of tasks.

11. A task management system for managing scheduling of tasks in a first operating system, comprising:
a task management section which manages the execution of a plurality of tasks using a function of a second operating system different from the first operating system and which is executed by the first operating system; and
a task execution control section that allows a first task of said plurality of tasks to be executed by the first operating system, when said first task is determined to execute a module executable only by the first operating system.

12. The task management system according to claim 11, wherein the plurality of tasks are generated as the tasks executable on the first operating system,
the task management section changes an execution state indicating whether or not the plurality of tasks can be executed on the first operating system to schedule the plurality of tasks, and
the task execution control section stops the scheduling of said first task by the task management section to allow said first task to be scheduled by the first operating system and to allow said first task to be executed by the first operating system, when said first task is determined to execute the module executable only by the first operating system.

13. The task management system according to claim 11, wherein the task execution control section returns said first task to a state scheduled by the task management section, when the execution of the module executable only by the first operating system is judged to have been ended.

14. A computer program product recorded on computer-readable medium for managing scheduling of tasks by a task management system on a computer using a first operating system, comprising:
first computer readable means for scheduling and managing a plurality of tasks by said first operating system; and
second computer readable means for allowing a first task of said plurality of tasks to be scheduled at a priority higher than that of the first computer readable means when said first task is determined to be scheduled in preference to the other of said plurality of tasks.

15. A computer program product for managing scheduling of tasks by a computer using a first operating system, comprising:
first computer readable means for managing a plurality of tasks using a function of a second operating system different from the first operating system and which is executed by the first operating system; and
second computer readable means for allowing a first task of said plurality of tasks to be executed by the first operating system, when said first task is determined to execute a module executable only by the first operating system.

16. A method for controlling scheduling of tasks in a first operating system, comprising the steps of:
assigning a scheduling priority to each of a plurality of tasks using a first operating system; and
scheduling one of said plurality of tasks at a priority higher than that assigned to it when said first task is determined to require a higher scheduling priority than it was originally assigned.

17. A method for controlling a task management system for managing scheduling of tasks by a computer in a first operating system, comprising:
a task management step of managing a plurality of tasks using a function of a second operating system different from the first operating system, the step being executed by the first operating system; and
a task execution control step of allowing the one task to be scheduled by the first operating system, when the one task in the plurality of tasks is judged to execute a module executable only by the first operating system.
